(19) United States
(12) Patent Application Publication
(10) Pub. No.: US 2010/0280658 A1
(43) Pub. Date: Nov. 4, 2010

(54) AUTOMATED VENDING SYSTEM AND METHOD

(75) Inventors: Chun-Hua HSIA, Taipei County (TW); Ming-Chung WANG, Taipei County (TW); Ching-Shun WANG, Taipei County (TW)

Correspondence Address: MCNEES WALLACE & NURICK LLC, 100 PINE STREET, P.O. BOX 1166, HARRISBURG, PA, 17108-1166, US

(73) Assignee: ADVANCED CONNECTION TECHNOLOGY INC., Taipei County (TW)

(21) Appl. No.: 12/433,148

(22) Filed: Apr. 30, 2009

(51) Int. Cl. G07F 7/00; G06Q 10/00; G06F 17/00; H04M 3/42

(52) U.S. Cl. 700/236; 705/34; 455/466

(57) ABSTRACT

An automated vending system includes an automated vending machine and an account managing device for managing purchase transactions made with the automated vending machine. The automated vending machine includes an article dispenser operable to dispense an article, a memory unit storing a user phone number, a communication module, and a processing unit. The communication module is assigned with a first phone number and is adapted to receive a request made by a user through operating a mobile phone assigned with a second phone number to dial the first phone number. The processing unit is operable to determine if the second phone number contained in the request has a match with the user phone number stored in the memory unit, and controls the article dispenser to enable dispensing of the article when the second phone number has a match with the user phone number.

### BACKGROUND OF THE INVENTION

1. Field of the Invention

The present invention relates to automated vending system and method, more particularly to an automated vending system that includes an automated vending machine and to an automated vending method implemented using the automated vending system.

2. Description of the Related Art

In general, a user of a conventional automated vending machine has to prepare some coins when making a purchase from the conventional automated vending machine. It is inconvenient for the user to prepare coins, and thus automated vending machines having a function of accepting a credit card or a debit card for payment have been proposed heretofore.

As mobile telecommunication products are popular, an automated vending method to be implemented using a blue tooth or infrared interface of a mobile telecommunication product has been proposed. For example, Taiwanese Patent Publication No. 523722 discloses an automated vending machine transaction method allowing a user to make a transaction with an automated vending machine by means of the blue tooth or infrared interface to transmit identification data stored in a subscriber identity module (SIM) card of the user's mobile phone or personal digital assistant (PDA). Although it is practicable to use the blue tooth or infrared interface to transmit the identification data stored in the SIM card, not every one understands how to operate the blue tooth or infrared interface. Moreover, purchase transactions may fail when a standard of a wireless transmission module of the automated vending machine does not match that of the user's mobile phone or PDA.

Additionally, some telecommunication service providers offer the use of mobile phone communication for purchase transactions made with an automated vending machine. However, the telecommunication service providers normally charge extra fees for such services.

### SUMMARY OF THE INVENTION

Therefore, an object of the present invention is to provide an automated vending system comprising an automated vending machine and an account managing device for managing purchase transactions made with the automated vending machine.

Another object of the present invention is to provide an automated vending machine.

Accordingly, an automated vending machine of this invention comprises an article dispenser operable to dispense an article, a memory unit storing at least one user phone number, a communication module, and a processing unit coupled to the memory unit, the communication module and the article dispenser. The communication module is assigned with a first phone number and is adapted to receive a request made by a user through operating a mobile phone of the user to dial the first phone number. The request contains a second phone number assigned to the mobile phone of the user. The processing unit is operable to determine if the second phone number contained in the request received by the communication module has a match with the at least one user phone number stored in the memory unit, and controls the article dispenser to enable dispensing of the article when the second phone number contained in the request has a match with the at least one user phone number stored in the memory unit.

A further object of the present invention is to provide an automated vending method.

According to another aspect of the present invention, there is provided an automated vending method to be implemented using an automated vending system that includes an automated vending machine. The automated vending machine stores at least one user phone number and is assigned with a first phone number. The automated vending method comprises:

upon receipt of a request made by a user through operating a mobile phone of the user to dial the first phone number, in which the request contains a second phone number assigned to the mobile phone of the user, configuring the automated vending machine to determine if the second phone number contained in the request has a match with the at least one user phone number stored therein, and to enable dispensing of an article when the second phone number contained in the request has a match with the at least one user phone number stored in the automated vending machine.

### BRIEF DESCRIPTION OF THE DRAWINGS

Other features and advantages of the present invention will become apparent in the following detailed description of the preferred embodiments with reference to the accompanying drawings, of which:

FIG. 1 is a system block diagram of a preferred embodiment of an automated vending system of the present invention; and

FIG. 2 is a flow chart illustrating a preferred embodiment of an automated vending method of the present invention.

### DETAILED DESCRIPTION OF THE PREFERRED EMBODIMENTS

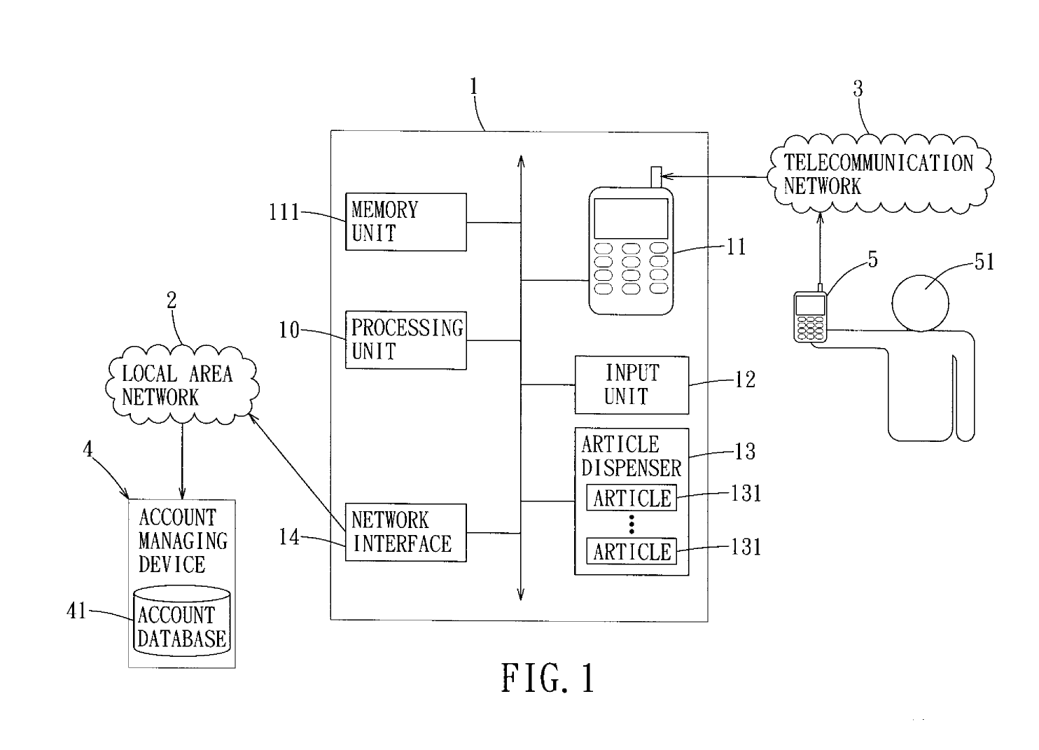

Referring to FIG. 1, a preferred embodiment of an automated vending system of the present invention includes an automated vending machine 1 and an account managing device 4. The account managing device 4 includes an account database 41 storing a predetermined account of a user. The automated vending machine 1 includes an input unit 12, an article dispenser 13, a memory unit 111, a communication module 11, a processing unit 10, and a network interface 14.

The input unit 12 is operable to allow a user 51 to select a desired one of articles 131 stored in the article dispenser 13. The article dispenser 13 is operable to dispense the selected one of the articles 131 that is to be sold to the user 51. For instance, the article dispenser 13 includes a controller, a delivery channel for delivering the selected one of the articles 131, and a gate disposed at an outlet of the delivery channel. The controller is operable to control the gate to open, such that the delivery channel is operable to deliver the selected one of the articles 131 through the outlet thereof. In practice, the article dispenser 13 has various configurations, and those skilled in the art can apply a similar mechanism during the practice of this invention. Further details of the article dispenser 13 will be omitted herein for the sake of brevity.

The memory unit 111 stores at least one user phone number. The communication module 11 has a SIM card assigned with a first phone number and is adapted to receive a purchase request made by the user 51 through operating the mobile phone 5 of the user 51 to dial the first phone number. The purchase request contains a second phone number assigned to the mobile phone 5 of the user 51. When the user 51 uses the mobile phone 5 to dial the first phone number assigned to the communication module 11, the communication module 11 receives the purchase request through the telecommunication network 3 without answering the call from the mobile phone 5. Therefore, no extra fees are incurred by the user 51.

The processing unit 10 is coupled to the memory unit 111, the communication module 11, the input unit 12 and the article dispenser 13. The processing unit 10 is operable to determine if the second phone number contained in the purchase request received by the communication module 11 has a match with the user phone number stored in the memory unit 111. When the second phone number contained in the purchase request has a match with the user phone number stored in the memory unit 111, the processing unit 10 controls the input unit 12 to allow the user 51 to select the desired one of the articles 131, and the article dispenser 13 to enable dispensing of the selected one of the articles 131. Further, the processing unit 10 generates a purchase notification that indicates a successful purchase transaction made between the user 51 of the mobile phone 5 and the automated vending machine 1. On the other hand, when the second phone number contained in the purchase request does not have a match with the user phone number stored in the memory unit 111, the processing unit 10 disables operation of the input unit 12 and the article dispenser 13.

The network interface 14 is coupled to the processing unit 10 for transmitting the purchase notification to the account managing device 4 through a local area network (LAN) 2. In response to the purchase notification received from the automate vending machine 1, the account managing device 4 is operable to manage purchase transactions made with the automated vending machine 1. For instance, the account managing device 4 is operable to charge a credit amount, which corresponds to a selling price of the selected one of the articles 131 that was dispensed, to the predetermined account of the user 51 stored in the account database 41 thereof. Alternatively, the account managing device 4 is operable to add a purchase item, which corresponds to a selling price of the selected one of the articles 131 that was dispensed, to a purchase record of the user 51 and to periodically generate a statement of the purchase record of the user 51. For example, the predetermined account could be a salary account of the user 51 when the user is a staff of a company that provides the automated vending system of this invention. Moreover, the processing unit 10 can be configured to control the communication module 11 to send the purchase notification to the mobile phone 5 of the user 51.

It should be noted that the automated vending system of this invention allows a plurality of users to purchase articles 131 therefrom. Therefore, the account database 41 of the account managing device 4 stores a plurality of the predetermined accounts of the users, and each of the predetermined accounts is specified by a mobile phone number of each of the users. Additionally, the memory unit 111 of the automated vending machine 1 also stores a plurality of user phone numbers corresponding to the users, respectively.

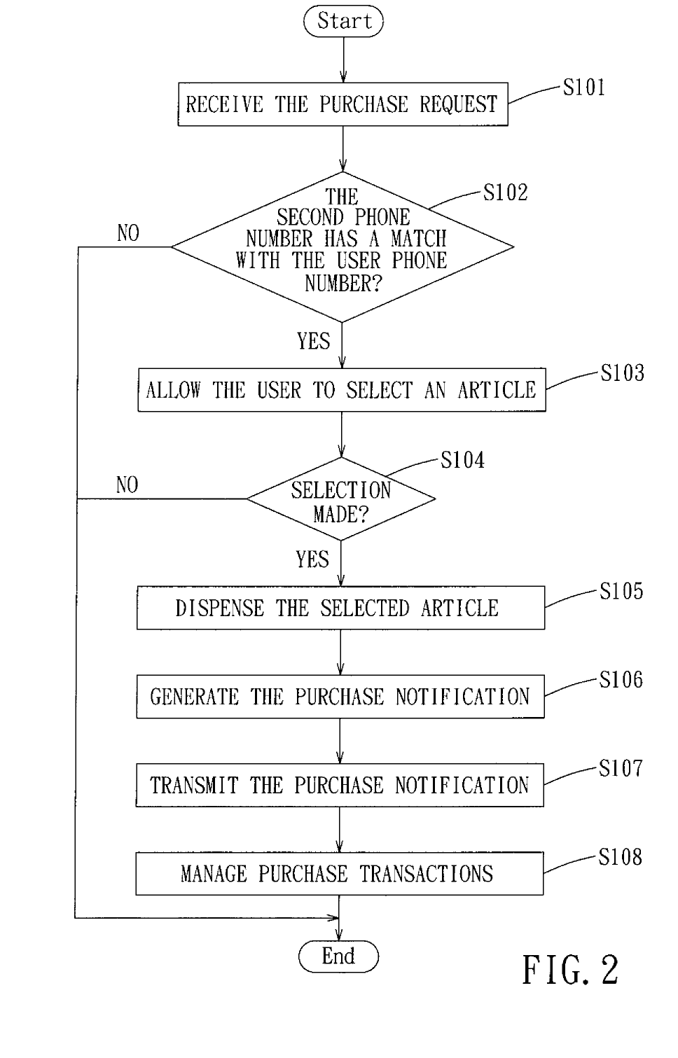

Further referring to FIG. 2, a preferred embodiment of an automated vending method is implemented using the automated vending system shown in FIG. 1, and will now be described in the succeeding paragraphs.

When the communication module 11 of the automated vending machine 1 receives the purchase request made by the user 51 through operating the mobile phone 5 assigned with the second phone number to dial the first phone number assigned to the communication module 11 in step (S101), the processing unit 10 of the automated vending machine 1 determines if the second phone number contained in the purchase request has a match with the user phone number stored in the memory unit 111 in step (102). If the second phone number contained in the purchase request does not have a match with the user phone number stored in the memory unit 111, the purchase request is denied, and the procedure of the automated vending method ends without a purchase transaction. On the other hand, if the second phone number has a match with the user phone number, the automated vending machine 1 allows the user 51 to select a desired one of the articles 131 via the input unit 12 in step (S103). Subsequently, the automated vending machine 1 determines if the user 51 already made a selection, and what the selected one of the articles 131 is in step (104). If the user 51 did not make a selection, the procedure of the automated vending method ends without a purchase transaction. On the other hand, if the user 51 made a selection, the article dispenser 13 of the automated vending machine 1 dispenses the selected one of the articles 131 in step (S105).

In step (S106), the automated vending machine 1 generates the purchase notification that indicates a successful purchase transaction made between the user 51 and the automated vending machine 1, and then transmits the purchase notification to the account managing device 4 of the automated vending system in step (S107). In response to the purchase notification received from the automated vending machine 1, the account managing device 4 manages purchase transactions made with the automated vending machine 1 in step (S108). For example, the account managing device 4 charges a credit amount, which corresponds to a selling price of the selected one of the articles 131 that was dispensed, to a predetermined account of the user 51 of the mobile phone 5. Alternatively, the account managing device 4 adds a purchase item, which corresponds to the selected one of the articles 131 that was dispensed, to a purchase record of the user 51 of the mobile phone 5, and periodically generates a statement of the purchase record that is subsequently sent to the user 51.

In sum, by virtue of the automated vending system and method of the present invention, any mobile phone can be operated to send the purchase request to the automated vending machine 1. Moreover, the user does not incur extra fees, because the communication module 11 will not answer the call from the mobile phone when receiving the purchase request.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An automated vending system comprising an automated vending machine and an account managing device for managing purchase transactions made with said automated vending machine, said automated vending machine including
an article dispenser operable to dispense an article that is to be sold to a user,
a memory unit that stores at least one user phone number,
a communication module that is assigned with a first phone number and that is adapted to receive a purchase request made by the user through operating a mobile phone of the user to dial the first phone number, wherein the purchase request contains a second phone number assigned to the mobile phone of the user,
a processing unit coupled to said memory unit, said communication module and said article dispenser, said processing unit being operable to determine if the second phone number contained in the purchase request received by said communication module has a match with said at least one user phone number stored in said memory unit, controlling said article dispenser to enable dispensing of the article that is to be sold to the user when the second phone number contained in the purchase request has a match with said at least one user phone number stored in said memory unit, and generating a purchase notification that indicates a successful purchase transaction made between the user of the mobile phone and said automated vending machine, and
a network interface coupled to said processing unit for transmitting the purchase notification to said account managing device.

2. The automated vending system as claimed in claim 1, wherein, in response to the purchase notification received from said automated vending machine, said account managing device is operable to charge a credit amount, which corresponds to a selling price of the article that was dispensed, to a predetermined account of the user of the mobile phone.

3. The automated vending system as claimed in claim 1, wherein, in response to the purchase notification received from said automated vending machine, said account managing device is operable to add a purchase item, which corresponds to the article that was dispensed, to a purchase record of the user of the mobile phone.

4. The automated vending system as claimed in claim 3, wherein said account managing device is further operable to periodically generate a statement of the purchase record of the user of the mobile phone.

5. An automated vending machine comprising:
an article dispenser operable to dispense an article;
a memory unit that stores at least one user phone number;
a communication module that is assigned with a first phone number and that is adapted to receive a request made by a user through operating a mobile phone of the user to dial the first phone number, wherein the request contains a second phone number assigned to the mobile phone of the user; and
a processing unit coupled to said memory unit, said communication module and said article dispenser, said processing unit being operable to determine if the second phone number contained in the request received by said communication module has a match with said at least one user phone number stored in said memory unit, and controlling said article dispenser to enable dispensing of the article when the second phone number contained in the request has a match with said at least one user phone number stored in said memory unit.

6. An automated vending machine comprising:
an article dispenser operable to dispense an article that is to be sold to a user;
a memory unit that stores at least one user phone number;
a communication module that is assigned with a first phone number and that is adapted to receive a purchase request made by the user through operating a mobile phone of the user to dial the first phone number, wherein the purchase request contains a second phone number assigned to the mobile phone of the user;
a processing unit coupled to said memory unit, said communication module and said article dispenser, said processing unit being operable to determine if the second phone number contained in the purchase request received by said communication module has a match with said at least one user phone number stored in said memory unit, controlling said article dispenser to enable dispensing of the article that is to be sold to the user when the second phone number contained in the purchase request has a match with said at least one user phone number stored in said memory unit, and generating a purchase notification that indicates a successful purchase transaction made between the user of the mobile phone and said automated vending machine; and
a network interface coupled to said processing unit for transmitting the purchase notification to an account managing device responsible for managing purchase transactions made with said automated vending machine.

7. An automated vending method to be implemented using an automated vending system that includes an automated vending machine, the automated vending machine storing at least one user phone number and being assigned with a first phone number, said automated vending method comprising:
a) upon receipt of a request made by a user through operating a mobile phone of the user to dial the first phone number, in which the request contains a second phone number assigned to the mobile phone of the user, configuring the automated vending machine to determine if the second phone number contained in the request has a match with said at least one user phone number stored therein, and to enable dispensing of an article when the second phone number contained in the request has a match with said at least one user phone number stored in the automated vending machine.

8. The automated vending method as claimed in claim 7, further comprising:
b) charging a credit amount, which corresponds to a selling price of the article that was dispensed, to a predetermined account of the user of the mobile phone.

9. The automated vending method as claimed in claim 8, the automated vending system further including an account managing device responsible for managing purchase transactions made with the automated vending machine, wherein:
in step a), the automated vending machine is further configured to generate a purchase notification that indicates a successful purchase transaction made between the user of the mobile phone and the automated vending machine, and to transmit the purchase notification to the account managing device; and
the account managing device is configured to perform step b).

10. The automated vending method as claimed in claim 7, further comprising:
c) adding a purchase item, which corresponds to the article that was dispensed, to a purchase record of the user of the mobile phone.

11. The automated vending method as claimed in claim 10, further comprising:
d) periodically generating a statement of the purchase record of the user of the mobile phone.

12. The automated vending method as claimed in claim 11, the automated vending system further including an account managing device responsible for managing purchase transactions made with the automated vending machine, wherein:
in step a), the automated vending machine is further configured to generate a purchase notification that indicates a successful purchase transaction made between the user of the mobile phone and the automated vending machine, and to transmit the purchase notification to the account managing device; and
the account managing device is configured to perform steps c) and d).

13. The automated vending method as claimed in claim 10, the automated vending system further including an account managing device responsible for managing purchase transactions made with the automated vending machine, wherein:
in step a), the automated vending machine is further configured to generate a purchase notification that indicates a successful purchase transaction made between the user of the mobile phone and the automated vending machine, and to transmit the purchase notification to the account managing device; and
the account managing device is configured to perform step c).
